(19) United States
(12) Patent Application Publication
(10) Pub. No.: US 2005/0237388 A1
(43) Pub. Date: Oct. 27, 2005

(54) Self-propelled cleaner with surveillance camera

(75) Inventor: Takao Tani, Osaka (JP)

Correspondence Address: Yokoi & Co., U.S.A., Inc., 13700 Marina Pointe Drive #1512, Marina Del Rey, CA, 90292, US

(73) Assignee: Funai Electric Co., Ltd., Osaka (JP)

(21) Appl. No.: 11/107,174

(22) Filed: Apr. 15, 2005

(30) Foreign Application Priority Data
Apr. 16, 2004 (JP) JP2004-121743

(51) Int. Cl. H04N 7/18

(52) U.S. Cl. 348/143

(57) ABSTRACT

The conventional self-propelled cleaners can detect surrounding obstacles but cannot detect steps, and therefore require additional one or more sensors. In a self-propelled cleaner according to the present invention, a plurality of camera devices are provided, each with a different VF angle and each mounted at a different elevation angle, and an image output processor, after facing the body toward the detected human based on detection result of a human sensor that detects the presence of a human around the body, takes an image of the human with each of said plurality of camera devices, inputs the image data, and then outputs said image data in a predetermined manner. This eliminates the time and the mechanism required for zooming and/or focusing.

### BACKGROUND OF THE INVENTION

1. Field of the Invention

The present invention relates to a self-propelled cleaner comprising a body equipped with a cleaning mechanism and a drive mechanism capable of steering and driving, as well as a plurality of surveillance cameras.

2. Description of the Prior Art

Conventionally, there is known a self-propelled robot equipped with a plurality of video cameras that is used to control the behavior of said self-propelled robot (refer to the Japanese Patent Laid-Open No. 2003-150246, for example).

The conventional self-propelled robot described above takes surrounding images with the same video camera and processes the images at different processing speeds, to be used for behavioral control. Therefore, when using said self-propelled robot to monitor an intruder or the like, if the intruder is not exactly within an imaging range, the images taken with said video camera will be useless.

It is theoretically possible to provide a zooming and/or angle-adjusting mechanism to the video camera so as to capture the face or whole body of an intruder, but if it takes a long time to control the video camera, the intruder may go out of the imaging range, and using a CPU with a higher processing speed to increase the control speed will result in high cost and an increased consumption of a battery. Furthermore, employing an actuator for the zooming and/or angle-adjusting mechanism will hamper a high-speed processing and consume more battery. The self-propelled cleaners should be free from these problems.

### SUMMARY OF THE INVENTION

The present invention has been made in view of the foregoing problems, and is intended to provide a self-propelled cleaner equipped with a plurality of surveillance cameras capable of taking an image of an intruder with a simple construction.

One embodiment of the present invention resides in a self-propelled cleaner comprising a body equipped with a cleaning mechanism and a drive mechanism capable of steering and driving said self-propelled cleaner, said body further comprising: a plurality of camera devices each with a different VF (hereinafter abbreviated to “VF”) angle and each mounted at a different elevation angle; a plurality of human sensors capable of sensing a human around the body to determine which way the human is; and an image output processor that faces said body toward the detected human based on the detection result of said human sensor, takes an image of the human with each of said plurality of camera devices to input the image, and then outputs said image in a predetermined manner.

The present invention configured as above has a plurality of camera devices each with a different VF angle and each mounted at a different elevation angle, and the image output processor faces the body toward the detected human based on the detection result of the human sensor which detects the presence of a human around the body, takes an image of the human with each of said plurality of camera devices to input the image taken, and then outputs said image in a predetermined manner.

This self-propelled cleaner is equipped with a plurality of camera devices each with a different VF angle and each mounted at a different elevation angle, and each camera device attempts to take an image of a human within a predetermined VF angle, when the image is taken with the body facing toward the detected human. Since the elevation angle of a camera device with a narrow VF angle is so preset that the face of an intruder will come at the center of the image, if the intruder has an expected height and posture, the face of the intruder should be at the center of the image taken. If the intruder moves quick or has an unexpected posture, the intruder's face maybe out of the image taken with a camera device with a narrow VF angle. However, the image of the intruder is taken with a camera device with a wide VF angle at the same time, even if the intruder's face is out of the narrow VF angle, the camera device with a wide VF angle can capture the intruder without fail.

Thus, an actuator and/or a zoom mechanism is not required for each camera device, and also a failure to capture an intruder is unlikely since multiple camera devices take images of the intruder, which eliminates additional time and electric power required for adjusting the image taking range.

It is necessary to change the setting of the VF angle appropriately, depending on the performance of the camera device, the sensing range of the human sensor, or the traveling performance of the body. As one embodiment, the plurality of camera devices may be made to include a camera device with a standard VF angle and one with a wide VF angle, wherein the elevation angle of the standard VF angle camera device is slightly lower than that of the wide VF angle camera device, and the wide VF angle camera device has an elevation angle within which part of the floor is included.

In this embodiment, the wide VF angle camera device has an elevation angle within which part of the floor is included and therefore it is possible to capture the whole body of an intruder from foot to head. As for the narrow VF angle camera device, its elevation angle is slightly lower than that of the wide VF angle camera device to compensate for the narrow VF angle, whereby the face of the intruder can be within the image taking range of the narrow VF angle camera device.

Regarding the human sensor detecting a human, various types of human sensors can be employed. As one embodiment, said human sensor may be made to detect an infrared-emitting object, based on changes in the amount of received infrared light, and also a plurality of human sensors may be disposed at the sides of said body.

In this configuration, since an infrared is radiated from the skin of a human, when an intruder comes in, the radiation of the infrared changes with the movement of the intruder, and thereby the amount of infrared light received by said human sensor changes. Therefore, the human sensor can detect the human radiating infrared.

Moreover, in order to utilize the detection results of these human sensors effectively, said image output processor may be made to determine a relative angle between the intruder and said body, based on the detection results of the plurality of human sensors, change the rotation angle of said body so as to eliminate said relative angle, and then causes said camera devices to take images.

A human sensor that detects an infrared-emitting object may not always detect a distance to the object accurately, but if there are multiple human sensors, it is possible to determine the relative angle between the object and said body, based on the detection result of each human sensor. For example, if adjoining two human sensors output detection result with the same intensity, then it is determined that there is an intruder between the two human sensors. Also, when equally spaced three human sensors detected a human, if the middle human sensor outputs the most intense detection result and the other two human sensors output detection results with the same intensity but lower that that of the middle human sensor, then it is determined that there is an intruder ahead of the middle human sensor.

There are various methods of outputting taken images. As one embodiment, said image output processor may be made to have a wireless transmitter that wirelessly transmits the image data taken with said camera devices to the outside.

In this embodiment, since the image data is transmitted to an external apparatus located away from the body, even if an intruder attempts to break the body, the image data has already been output to the outside and therefore the image data is safe, thus making it possible to report to the police with the image of the intruder attached.

There are various standards for wireless transmission. As a simple embodiment, said wireless transmitter may be made to be a wireless LAN module, and said image output processor may be made to output the image data taken with said plurality of camera devices, according to a predetermined protocol.

In this embodiment, it is possible to connect to an access point of a wired LAN via a wireless LAN module provided in the body, and transmit image data to a predetermined destination, on the assumption that a wired LAN is available.

It is also possible to connect to a wired LAN and further to the Internet, thus allowing an E-mail including said image data to be transmitted to a predetermined user via the Internet.

The user can view the transmitted image data and report to the police immediately, if an intruder is captured in the image.

Meanwhile, said image output processor may be made to temporarily store the image data taken with said plurality of camera devices, and transmit the stored image data when said wireless transmitter becomes available for transmission.

In this embodiment, the image data taken with the plurality of camera devices is temporarily stored in a predetermined memory area. The image of an intruder must be taken as soon as the intruder is detected. Even more so when a low-speed CPU is used. Meanwhile, it often takes certain time for the wireless transmitter to transmit the image data to the outside, especially when the wireless transmitter is turned off for power saving. In addition, there is a case where transmission is impossible without using a predetermined protocol, such as a transmission via a LAN. Therefore, to prevent the intruder from going out of the imaging range while this transmission-starting procedure is performed, the image data taken is temporarily stored in the predetermined memory area, and then transmitted by the wireless transmitter when it becomes available for transmission.

This make it possible to take an image of the intruder quickly without fail.

Moreover, said image output processor may be made to continue to take images of an intruder with said plurality of camera devices while the intruder is detected by said human sensor, and transmit the image data after taking a predetermined number of images, or when said human sensor does not detect the intruder any more.

In this embodiment, said plurality of camera devices continue to take images of the intruder while the human sensor is detecting the intruder. By giving priority to taking images as long as the human sensor is detecting the intruder, even if the intruder's image fails to be captured once, it may be captured next time, and consequently it is possible to take as many images as possible.

After the storable number of images have been taken, or when the human sensor does not detect the intruder any more, the taken images are transmitted by the wireless transmitter. In other words, by delaying the processing required for wireless transmission of the image data, it is possible to take as many images as possible.

However, even if the plurality of camera devices with different VF angles and elevations angles are provided, when the area within the image taking range is dark, it may be impossible to take images. Therefore, said image output processor may be made to have an illumination device facing the image taking range of said plurality of camera devices and to face said body toward the detected intruder, and at the same time illuminate the image taking range with said illumination device.

According to this embodiment, it is possible to face the body toward the intruder and also illuminate the image taking range with the illumination device. This prevents the camera devices from skipping image-taking operation done by sensing deficient intensity of illumination.

Regarding the cleaning mechanism, a suction type cleaning mechanism, a brush type that sweeps together dust with a brush, or a combination type can be employed. The drive mechanism capable of steering and driving the self-propelled cleaner can also be implemented in various ways. The drive mechanism can be implemented using endless belts instead of wheels. Needless to say, other constructions such as four wheels or six wheels are also possible.

As a more specific embodiment based on the foregoing embodiments, there may be provided a self-propelled cleaner comprising a body equipped with a cleaning mechanism and a drive mechanism equipped with drive wheels that are disposed at both sides of said body, and their rotations can be controlled individually to enable steering and driving of said self-propelled cleaner, wherein said body further comprises: a standard VF angle camera device and a wide VF angle camera device, wherein said wide VF angle camera device is fixed at an elevation angle so that the floor is within the VF angle and said standard VF camera is fixed at an elevation angle lower than said elevation angle of the wide VF camera device; a plurality of human sensors that are disposed at the sides of the body and detect an. infrared-emitting object, based on changes in the amount of received infrared light; and an image output processor that determines a relative angle between the intruder and said body based on the detection results of these plurality of human sensors, changes the rotation angle of said body so as to eliminate said relative angle, causes said camera devices to take images of the intruder, and transmits the image data to the outside via a wireless LAN according to a predetermined protocol.

In this embodiment, the standard VF angle camera device and the wide VF angle camera device are mounted, each at a predetermined elevation angle, i.e., the wide VF angle camera device is mounted at an elevation angle so that the floor is within the VF angle, and the standard VF angle camera is mounted at an elevation angle lower than said elevation angle of the wide VF angle camera device, and when the plurality of human sensors disposed at the sides of the body detect an infrared-emitting object based on changes in the amount of received infrared light, the image output processor determines a relative angle between the intruder and said body, changes the rotation angle of said body so as to eliminate said relative angle, causes said camera devices to take images of the intruder, and then transmits the image data to the outside via a wireless LAN according to a predetermined protocol.

Thus, simply by implementing a drive to face the body toward an intruder, it is possible to take images of the face and whole body of the intruder with a simple configuration.

### BRIEF DESCRIPTION OF THE DRAWINGS

FIG. 1 is a block diagram showing the schematic construction of a self-propelled cleaner according to the present invention.

FIG. 2 is a more detailed block diagram of said self-propelled cleaner.

FIG. 3 is a block diagram of a passive sensor for AF.

FIG. 4 is an explanatory diagram showing the position of a floor relative to the passive sensor and how ranging distance changes when the passive sensor for AF is oriented obliquely toward the floor.

FIG. 5 is an explanatory diagram showing the ranging distance for imaging range when a passive sensor for AF for adjacent area is oriented obliquely toward a floor.

FIG. 6 is a diagram showing the positions and ranging distances of individual passive sensors for AF.

FIG. 7 is a flowchart showing a traveling control.

FIG. 8 is a flowchart showing a cleaning travel.

FIG. 9 is a diagram showing a travel route in a room to be cleaned.

FIG. 10 is an external perspective view of a camera system unit

FIG. 11 is a side view of a camera system unit showing its mounting procedure.

FIG. 12 is a diagram showing a display for selecting operation mode selection.

FIG. 13 is a flowchart showing the control steps in security mode.

FIG. 14 is a diagram showing the selection of image data output methods.

FIG. 15 is a diagram showing a display for setting an E-mail sending address

FIG. 16 is a diagram showing a display for setting whether or not evacuation actions are to be taken after taking an image.

### DESCRIPTION OF THE PREFERRED EMBODIMENTS

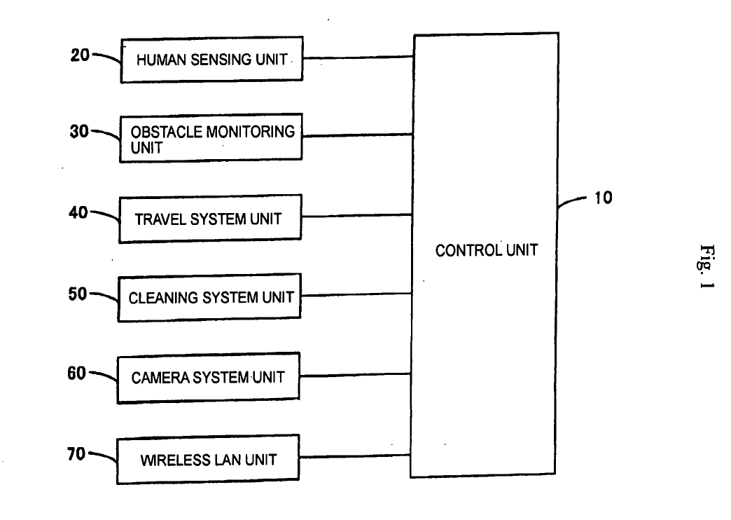

FIG. 1 is a block diagram showing the schematic construction of a self-propelled cleaner according to the present invention. As shown in the figure, the self-propelled cleaner comprises a control unit 10 to control individual units; a human sensing unit 20 to detect a human or humans around the self-propelled cleaner; an obstacle detecting unit 30 to detect an obstacle or obstacles around the self-propelled cleaner; a traveling system unit 40 for traveling; a cleaning system unit 50 to perform a cleaning task; a camera system unit 60 to take images within a predetermined range; and a wireless LAN unit 70 for wireless connection to a LAN. The body of the self-propelled cleaner has a flat rough cylindrical shape.

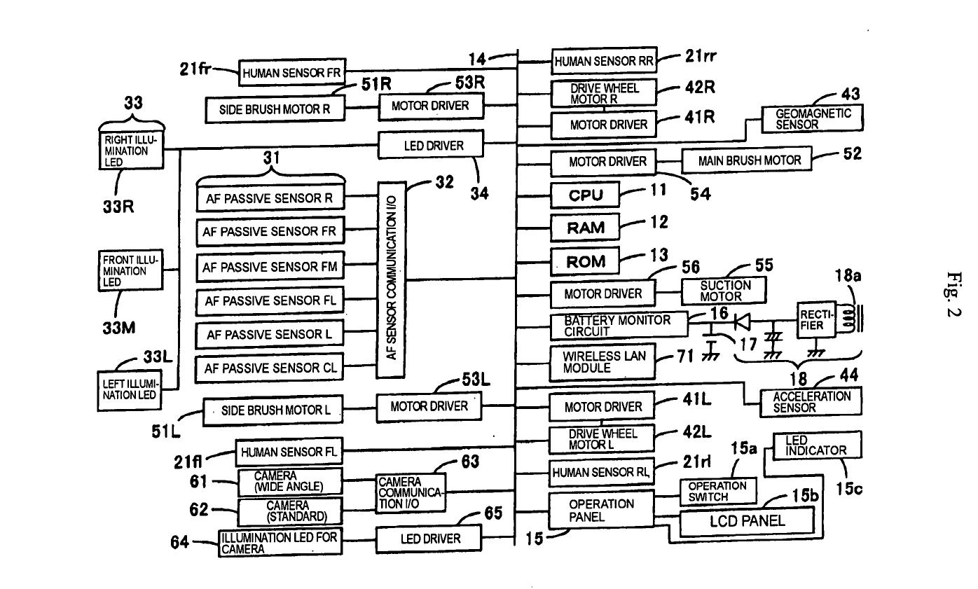

FIG. 2 is a block diagram showing the construction of an electric system that realizes the individual units concretely. A CPU 11, a ROM 13, and a RAM 12 are interconnected via a bus 14 to form the control unit 10. The CPU 11 performs various controls using the RAM 12 as a work area according to a control program stored in the ROM 13 and various parameter tables. The contents of said control program will be described later in detail.

The bus 14 is equipped with an operation panel 15 on which various types of operation switches 15a, an LED display panel 15b, and LED indicators 15c are provided. Although a monochrome LED panel capable of multi-tone display is used for the LED display panel, a color LED panel or the like can also be used.

This self-propelled cleaner has a battery 17, and allows the CPU 11 to monitor the remaining amount of the battery 17 through a battery monitor circuit 16. Said battery 17 is equipped with a charge circuit 18 that charges the battery with an electric power supplied non-contact through an induction coil 18a. The battery monitor circuit 16 mainly monitors the voltage of the battery 17 to detect its remaining amount.

The human sensing unit 20 consists of four human sensors 21 (21fr, 21rr, 21f1, 21r1), two of which are disposed obliquely on both sides of the front of the body and the other two on both sides of the rear of the body. Each human sensor 21 has a light-receiving sensor that detects the presence of a human based on the change in the amount of infrared light received. In order to change the status to be output when the human sensor detects an object with an emitted infrared light changing, the CPU 11 can obtain detection status of the human sensor 21 via the bus 14. That is, it is possible for the CPU 11 to obtain the status of each of the human sensors 21fr, 21rr, 21f1, and 21r1 at predetermined intervals, and detect the presence of a human in front of the human sensor 21fr, 21rr, 21f1, or 21r1 if the status changes.

Although the human sensor described above detects the presence of a human based on changes in the amount of infrared light, an embodiment of the human sensor is not limited to this. For example, if the CPU's processing capability is increased, it is possible to take a color image of the room to identify a skin-colored area that is characteristic of a human, and detect the presence of a human based on the size of the area and/or changes in the area.

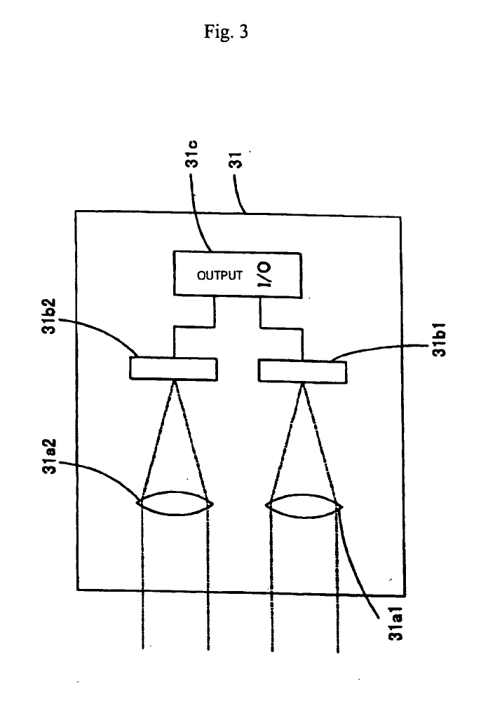

The obstacle monitoring unit 30 comprises the passive sensor 31 (31R, 31FR, 31FM, 31FL, 31L, 31CL) as a ranging sensor for auto focus (hereinafter referred to as AF); an AF sensor communications I/O 32 which is a communication interface to the passive sensor 31; an illumination LED 33; and an LED driver 34 to supply a driving current to each LED. First, the construction of the passive sensor for AF 31 will be described. FIG. 3 shows a schematic construction of the passive sensor for AF 31 comprising almost parallel biaxial optical systems 31a1, 31a2; CCD line sensors 31b1, 31b2 disposed approximately at the image focus locations of said optical systems 31a1 and 31a2 respectively; and an output I/O 31c to output image data taken by each of the CCD line sensors 31b1 and 31b2 to the outside.

The CCD line sensors 31b1, 31b2 each have a CCD sensor with 160 to 170 pixels and can output 8-bit data representing the amount of light for each pixel. Since the optical system is biaxial, formed images are misaligned according to the distances, which enables the distance to be measured based on a disagreement between data output from respective CCD line sensors 31b1 and 31b2. For example, the shorter the distance the larger the misalignment of formed images and vice versa. Therefore, an actual distance is determined by scanning data row for every four to five pixels in output data, finding a difference between the address of an original data row and that of a discovered data row, and then referencing a “difference to distance conversion table” prepared in advance.

Out of the passive sensors for AF, 31R, 31FR, 31FM, 31FL, 31L, 31CL, the 31FR, 31FM, 31FL are used to detect an obstacle located straight ahead of the self-propelled cleaner, the 31R, 31L are for detecting an obstacle located immediately ahead of the left or right side of the self-propelled cleaner, and the 31CL is for detecting a distance to the forward ceiling.

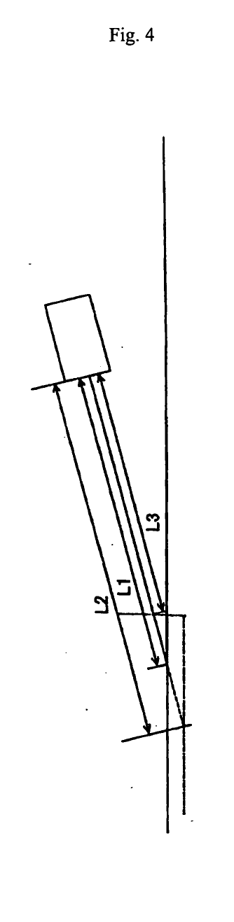

FIG. 4 shows the principle of detecting an obstacle located straight ahead of the self-propelled cleaner or immediately ahead of the left or right side of the self-propelled cleaner, by means of the passive sensors for AF 31. These passive sensors are mounted obliquely toward a forward floor. If there is no obstacle ahead, ranging distance of the passive sensor for AF 31 is L1 in almost whole image pick-up range. However, if there is a step as shown with a dotted line in the Figure, ranging distance becomes L2. Thus, extended ranging distance means that there is a downward step. Likewise, if there is an upward step as shown with a double-dashed line, ranging distance becomes L3. Ranging distance when an obstacle exists also becomes a distance to the obstacle as in the case of an upward step, and thus becomes shorter than the distance to the floor.

In this embodiment, if the passive sensor for AF 31 is mounted obliquely toward a forward floor, its image pick-up range becomes about 10 cm. Since the self-propelled cleaner is 30 cm in width, three passive sensors for AF, 31FR, 31FM, 31FL are mounted at slightly different angles from each other so that their image pick-up ranges will not overlap. This allows the three passive sensors for AF to detect any obstacle or step within a forward 30 cm range. Needless to say, detection range varies with the specification and/or mounting position of a sensor, in which case the number of sensors meeting actual detection range requirements may be used.

The passive sensors for AF, 31R, 31L, which detect an obstacle located immediately ahead of the right and left sides of the self-propelled cleaner, are mounted obliquely toward a floor relative to vertical direction. The passive sensor for AF 31R disposed at the left side of the body faces opposite direction so as to pick up an image of the area immediately ahead of the right side of the body and to the right across the body. The passive sensor for AF 31L disposed at the right side of the body also faces the opposite direction so as to pick up an image of the area immediately ahead of the left side of the body and to the left across the body.

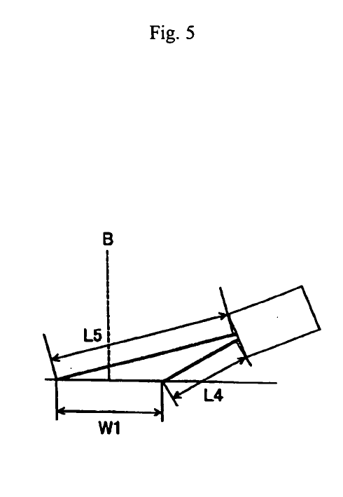

If said two sensors are disposed so that each sensor picks up an image of the area immediately ahead of the sensor, the sensor must be mounted so as to face a floor at a steep angle and consequently the image pick-up range becomes narrower, thus making it necessary to provide multiple sensors. To prevent this, the sensors are intentionally disposed cross-directionally to widen the image pick-up range, so that required range can be covered by as few sensors as possible. Meanwhile, mounting the sensor obliquely toward a floor relative to the vertical direction means that the arrangement of CCD line sensors is vertically directed and thus the width of an image pick-up range becomes W1 as shown in FIG. 5. Here, distance to the floor is short (L4) on the right of the image pick-up range and long (L5) on the left. If the border line of the side of the body is at the position of the dotted line B, an image pick-up range up to the border line is used for detecting a step or the like, and an image pick-up range beyond the border line is used for detecting a wall.

The passive sensor for AF 31CL to detect a distance to a forward ceiling faces the ceiling. The distance between the floor and ceiling to be detected by the passive sensor 31CL is normally constant. However, as the self-propelled cleaner approaches a wall, the wall, instead of the ceiling, enters in the image pick-up range and consequently the ranging distance becomes shorter, thus allowing a more precise detection of a forward wall.

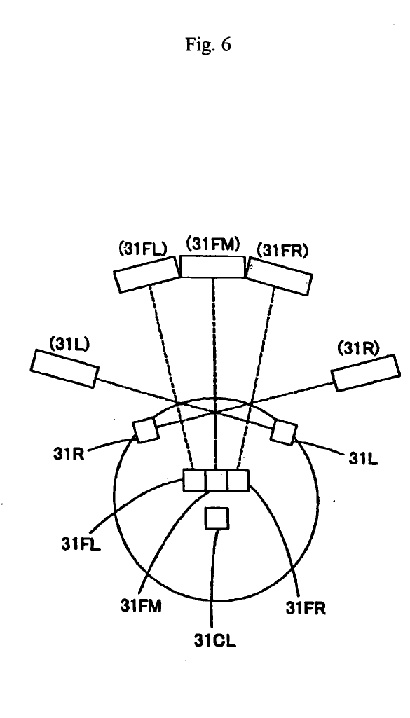

FIG. 6 shows the positions of the passive sensors for AF, 31R, 31FR, 31FM, 31FL, 31L, 31CL mounted on the body, and their corresponding image pick-up ranges on each floor in parentheses. The image pick-up ranges for a ceiling are not shown.

A right illumination LED 33R, a left illumination LED 33L, and a front LED 33M, all of which are white LED, are provided to illuminate the image pick-up ranges of the passive sensors for AF, 31R, 31FR, 31FM, 31FL, 31L. An LED driver 34 supplies a drive current to turn on these LEDs according to a control command from the CPU 11. This allows obtaining effective pick-up image data from the passive sensors for AF 31 even at night or at a dark place such as under a table.

The travel system unit 40 comprises motor drivers 41R, 41L; drive wheel motors 42R, 42L; and a gear unit (not shown) and drive wheels, both of which are driven by the drive wheel motors 42R, 42L. The drive wheel is disposed at both sides of the body, one at each side, and a free-rotating wheel without a driving source is disposed at the front center of the bottom of the body. The rotation direction and rotation angle of the drive wheel motors 42R, 42L can be finely regulated by the motor drivers 41R, 41L respectively, and each of the motor drivers 41R, 41L outputs a corresponding drive signal according to a control command from the CPU 11. Furthermore, the rotation direction and rotation angle of actual drive wheels can be precisely detected, based on the output from a rotary encoder mounted integrally with the drive motors 42R, 42L. Also, it is possible to dispose free-rotating driven wheels near the drive wheels, instead of directly coupling the rotary encoder to the drive wheels, and feed back the amount of rotation of said driven wheels. This enables actual rotational amount of the drive wheels to be detected even when the drive wheels is skidding. The travel system unit 40 further comprises a geomagnetic sensor 43 that enables travel direction to be determined according to geomagnetism. An acceleration sensor 44 detects accelerations in three axis (X, Y, Z) directions and outputs detection results.

Various types of gear unit and drive wheels can be adopted, including a drive wheel made of a circular rubber tire and an endless belt.

The cleaning mechanism of this self-propelled cleaner comprises side brushes disposed at both sides of the front of the self-propelled cleaner that sweeps together dust, etc. on the floor around both sides of the body, a main brush that scoops up the dust collected around the center of the body, and a suction fan that sucks in the dust swept together by said main brush at around the center of the body, and feed the dust to a dust box. The cleaning system unit 50 comprises side brush motors 51R, 51L and a main brush motor 52 to drive corresponding brushes; motor drivers 53R, 53L, 54 that supply drive current to the respective brush motors; a suction motor 55 to drive a suction fan; and a motor driver 56 that supplies current to said suction motor. During a cleaning, the side brushes and a main brush are controlled by the CPU 11 based on floor condition, condition of the battery, instruction of the user, etc.

The camera system unit 60 is equipped with two CMOS cameras 61, 62, each with a different VF angle, which are disposed at the front of the body and each set to a different elevation angle. The camera system unit further comprises a camera communication I/O 63 that instructs each of the cameras 61, 62 to take an image of a floor ahead and outputs the taken image; an illumination LED for a camera 64 consisting of 15 white LEDs directed toward an image to be taken by the cameras 61, 62; and an LED driver 65 to supply drive current to said LED for illumination.

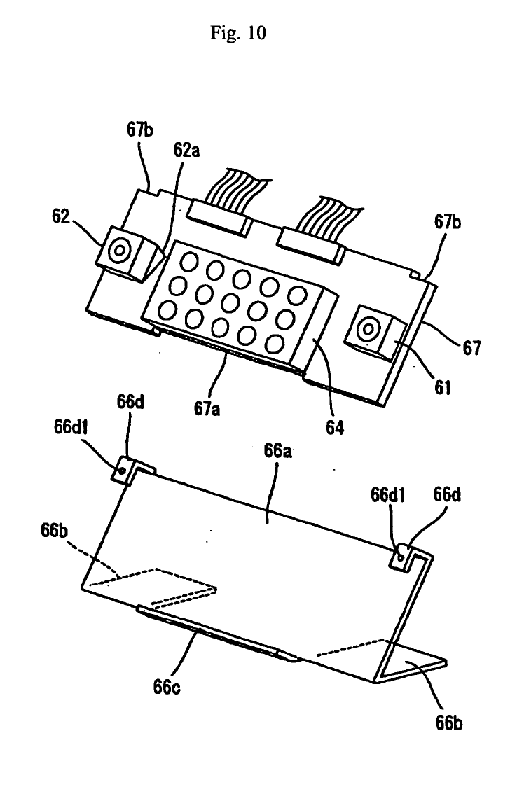

FIG. 10 is a perspective view of an appearance of a camera system unit 60.

The optional camera system unit 60 can be mounted on a mounting base 66 on the body that is formed by bending a metal plate. Abase board 67, on which said CMOS cameras 61, 62, camera illumination LEDs 64, and the like are mounted, is provided and designed to be screwed to said mounting base 66. The mounting base 66 comprises a base 66a; two legs 66b that extend backward from both sides of the lower edge of said base 66sa, in order to hold the base at about 45 degrees relative to horizontal direction; a convex support edge 66c that is bent at about right angle relative to the base 66a to support the lower edge of said base board 67; and fixing brackets 66d each with a tapped hole which extend upward flatly from both ends of the upper edge of the base 66a, and are bent at 90 degrees twice so that the end side faces the base 66a in parallel.

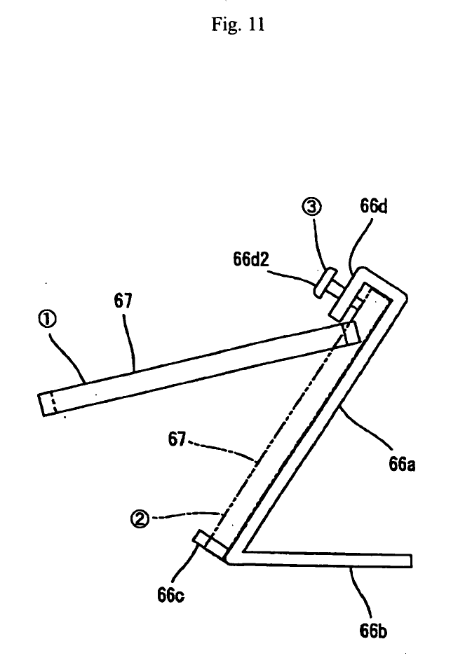

As shown in FIG. 11, first insert the upper end of the base board 67 between said fixing bracket 66d and the base 66a, and when the end of the base board 67 is inserted up to the innermost, push the lower end of it onto the convex support edge 66c, and finally fix the base board 67 by screwing a male screw 66d2 into a female screw 66d1 so that the base board 67 will not move. At both sides of the upper end of the base board 67 and at the center of the lower end of it, cuts 67a, 67b matching said fixing bracket 66d and the convex support edge 66c are respectively formed to allow precise positioning.

A CMOS camera 61 is a wide angle camera with a VF angle of 110 degrees, which is mounted on the base board 67 so that shooting direction is at right angle to the base board 67. Since its VF angle is 110 degrees and the base board 67 itself is mounted on the mounting base 66 tilted at 45 degrees, the imaging range becomes from 10 to 110 degrees below the horizontal plane. Therefore, the imaging range includes the floor surface.

The CMOS camera 62 is a standard (lens) angle camera with a VF angle of 58 degrees and is mounted on the base board 67 with a wedge-shaped adapter 62a placed under it, so that its shooting direction is at 15 degrees relative to the base board 67. Since the VF angle is 58 degrees, the imaging range is from 1 to 57 degrees relative to a horizontal plane. That is, if the camera is at a distance of 2 m from an object, the imaging range becomes from 0.034 to 3.078 m, in which case the object is likely to be imaged. In contrast, if an object is at a distance of 1 m from the camera, the imaging range becomes 0.017 to 1.539 m, in which case an intruder may not be imaged by the camera, depending on his or her posture.

However, since the imaging range of the CMOS camera 61 is from 10 to 110 degrees below a horizontal plane, which is sufficient as an imaging range, and a range from 1 m above the floor (i.e. the height of the camera) up to the ceiling is covered, it is highly likely that the face of an intruder is imaged.

Furthermore, since the CMOS cameras 61, 62 start to take images immediately after the body is positioned in place, and continues to take images, as described below, the time for positioning and focusing of the camera is not required, and therefore imaging opportunity will not be lost.

A wireless LAN unit 70 has a wireless LAN module 71, and the CPU 11 is capable of wirelessly connecting to an external LAN according to a predetermine protocol. If an access point (not shown) is available, it is possible to connect the wireless LAN module 71 through said access point to an external wide area network, such as the Internet, via routers or the like. This allows ordinary sending and receiving of E-mails or browsing Web sites over the Internet. The wireless LAN module 71 comprises a standardized card slot and a standardized wireless LAN card. Needless to say, any standardized card other than this card can be connected to the card slot.

Now, the operation of the self-propelled cleaner embodied as above will be described.

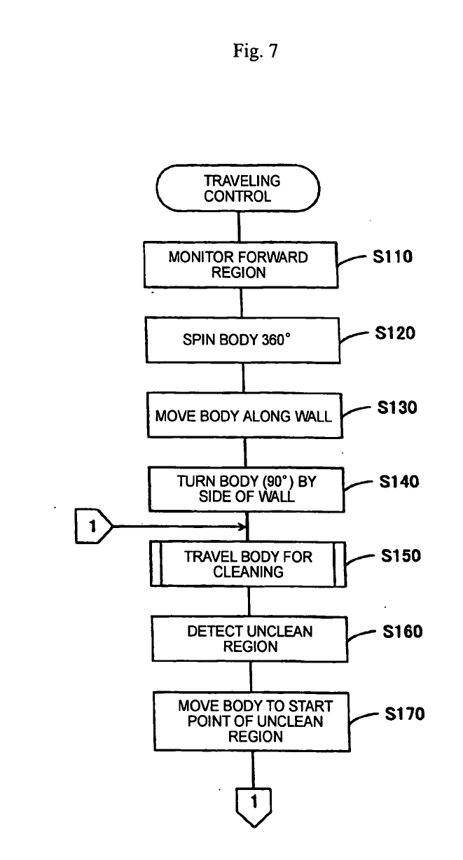

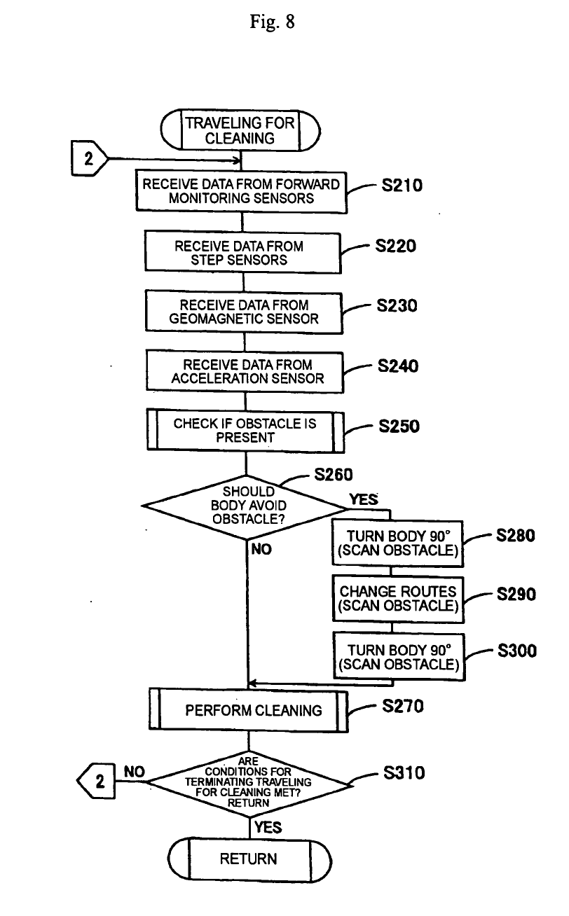

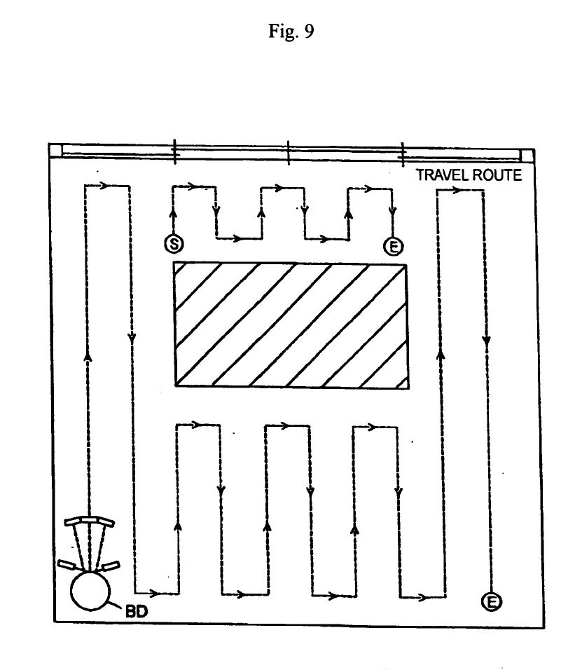

FIG. 7 and FIG. 8 show flowcharts corresponding to the control programs executed by said CPU 11, and FIG. 9 shows a route along which the self-propelled cleaner travels according to said control programs.

When the power is turned on, the CPU 11 starts the travel control shown in FIG. 7. In step S110, detection results of the passive sensor for AF 31 are input for monitoring a front area. The detection results of the passive sensors for AF, 31FR, 31FM, 31FL are used for monitoring the front area. If the area is flat, the distance to an obliquely down area of the floor, “L1” can be determined from the taken image (detection results). Based on the detection results of the individual passive sensors for AF, 31FR, 31FM, 31FL, it is possible to determine whether or not the front floor as wide as the body is flat. At this point, however, no information has been obtained about the floor ranging from the area each of the passive sensors for AF, 31FR, 31FM, 31FL is facing to that immediately before the body, and consequently that area becomes a blind spot.

In step S120, the CPU 11 commands the motor drivers 41R, 41L to drive the drive wheel motors 42R, 42L respectively, so as to rotate the drive wheel motors in a different direction from each other, but at the same numbers of rotation. As a result, the body starts to turn around at the same position. Since the number of rotations of the drive motors 42R, 42L required for a 360 degree spin turn at the same position is already known, the CPU 11 commands the motor drivers 41R, 41L to rotate the drive wheel motors at that number of rotations.

During a spin turn, the CPU 11 inputs detection results of the passive sensors for AF, 31R, 31L to determine the status of the floor immediately before the body. Said blind spot is almost eliminated by the detection results obtained during this period, and the flat floor around the body can be detected if there is no step or obstacle.

In step S130, the CPU 11 commands the motor drivers 41R, 41L to rotate the respective drive wheel motors 42R, 42L at the same number of rotations. As a result, the body starts to move strait ahead. During moving straight ahead, the CPU 11 inputs detection results of the passive sensors for AF, 31FR, 31FM, 31FL to move ahead the self-propelled cleaner, while determining whether or not any obstacle exists ahead. If a wall (an obstacle) is detected ahead of the self-propelled cleaner, based on said detection results, the self-propelled cleaner stops at a predetermined distance from the wall.

In step S140, the body turns to the right 90 degrees. The body stops at a predetermined distance from the wall in step S130. This predetermined distance is a distance within which the body can turn without colliding against the wall, and also a range outside the width of the body detected by the passive sensors for AF, 31R, 31L, which are used to determine the situation immediately ahead and to the right and left sides of the body. That is, in step S130 the body stops based on detection results of the passive sensors for AF, and when turning 90 degrees in step S140, the body stops at a distance within which at least the passive sensor for AF 31L can detect the position of the wall. When turning 90 degrees, the situation immediately ahead of the body is determined beforehand based on the detection results of said passive sensors for AF, 31R, 31L. FIG. 9 shows a case where a cleaning is started at the lower left corner of a room (cleaning start position) where the self-propelled cleaner reached in this way.

There are various methods of reaching the cleaning start position other than the one mentioned above. For example, only turning right 90 degrees when the self-propelled cleaner reached a wall may result in a cleaning being started at the middle of the first wall. Therefore, in order to reach an optimum start position at the lower left corner of the room as shown in FIG. 9, it is desirable for the self-propelled cleaner to turn left 90 degrees when it comes up against a wall, then move forward to the front wall, and turn 180 degrees when the self-propelled cleaner reached the wall.

In step S150, a cleaning travel is done. FIG. 8 shows a more detailed flow of said cleaning travel. Before traveling forward, detection results of various sensors are input in steps S210 to S240. Step S210 inputs data from the forward monitoring sensors, specifically, detection results of the passive sensors for AF, 31FR, 31FM, 31FL, 31CL, which are used to determine whether or not an obstacle or wall exists ahead of the traveling range. The forward monitoring includes the monitoring of the ceiling in a broad sense.

Step S220 inputs the data from step sensors, specifically, detection results of the passive sensors for AF, 31R, 31L, which are used to determine whether or not there is a step immediately ahead of the traveling range. When traveling along a wall or obstacle in parallel, a distance to the wall or obstacle is measured and the data thus obtained is used to determine whether or not the self-propelled cleaner is moving in parallel to the wall or obstacle.

Step S230 inputs data from a geomagnetic sensor, specifically the geomagnetic sensor 43, which is used to determine whether or not travel direction varies during a forward travel. For example, an angle of geomagnetism at the start of a cleaning travel is stored in memory, and if the angle detected during travel differs from the stored angle, then the travel direction is corrected back to the original angle, by slightly changing the number of rotations of either left or right drive wheel motor 42R, 42L. For example, if travel direction changed toward an angle-increasing direction (except for a change from 359 degree to 0 degree), it is necessary to correct the pass toward left direction by issuing a drive control command to the motor driver 41R, 41L to increase the number of rotations of the right drive wheel motor 42R slightly more than that of the left drive wheel motor 42L.

Step S240 inputs data from an acceleration sensor, specifically, detection results of the acceleration sensor 44, which is used to check for travel condition. For example, if an acceleration toward a roughly constant direction can be detected at the start of a forward travel, it is determined that the self-propelled cleaner is traveling normally. However, if a rotating acceleration is detected, it is determined that either drive wheel motor is not driven. Also, if an acceleration exceeding a normal range of values, it is determined that the self-propelled cleaner fell from a step or overturned. If a large backward acceleration is detected during a forward travel, it is determined that the self-propelled cleaner hit an obstacle located ahead. Although direct control of the travel, such as maintaining a target acceleration by inputting an acceleration value, or determining the speed of the self-propelled cleaner based on the integral value, is not performed, acceleration values are effectively used to detect abnormalities.

Step S250 determines whether an obstacle exists, based on detection results of the passive sensors for AF, 31FR, 31FM, 31CL, 31FL, 31R, 31L, which have been input in steps S210 and S220. The determination of an obstacle is made for the front, the ceiling, and the area immediately ahead. The front is checked for an obstacle or wall, the area immediately ahead is checked for a step and the situations to the right and left outside the traveling range, such as existence of a wall. The ceiling is checked for an exit of the room without a door by detecting a head jamb or the like.

Step S260 determines whether or not the self-propelled cleaner needs to get around based on detection results of each sensor. If the self-propelled cleaner needs not to get around, the cleaning process in step S270 is performed. The cleaning process is a process of sucking in dust on the floor while rotating the side brush and main brush, specifically, issuing commands to the motor drivers 53R, 53L, 54, 56 to drive motors 51R, 51L, 52, 55 respectively. Needless to say, said commands are issued at all times during a travel and are stopped when a terminating condition described below is satisfied.

In contrast, if it is determined that a circumvention is necessary, the self-propelled cleaner turns right 90 degrees in step S280. This turn is a 90 degree turn at the same position, and is caused by commanding the motor drivers 41R, 41L to rotate the drive wheel motors 42R, 42L in different direction from each other, and give a driving force to provide the number of rotations required for a 90 degree turn. The right drive wheel is rotated backward and the left drive wheel is rotated forward. While the wheels are rotating, detection results of step sensors, specifically the passive sensors for AF, 31R, 31L, are input to determine whether or not an obstacle exist. For example, when an obstacle is detected in front and therefore the self-propelled cleaner is turned right 90 degrees, if the passive sensor for AF 31R does not detect a wall immediately ahead on the right, it may be determined that the self-propelled cleaner comes near the front wall. However, if the passive sensor detects a wall immediately ahead on the right even after the turn, it may be determined that the self-propelled cleaner is at a corner. If neither of the passive sensors for AF, 31R, 31L detects an obstacle immediately ahead, it may be determined that the self-propelled cleaner comes near not a wall but a small obstacle.

In step S290, the self-propelled cleaner travels forward while scanning obstacles. When the self-propelled cleaner comes near a wall, it turns right 90 degrees and moves forward. If the self-propelled cleaner stops just before the wall, the forward travel distance is about the width of the body. After moving forward by that distance, the self-propelled cleaner makes a 90 degree right turn again in step S300.

During this travel, scanning of obstacles on front right and left sides is performed at all times to identify the situation, and the information thus obtained is stored in the memory.

Meanwhile, a 90 degree right turn is made twice in the above description, and therefore if a 90 degree right turn is made when another wall is detected in front, the self-propelled cleaner returns to the original position. To prevent this, the 90 degree turn is to be made alternately between right and left directions, such as, if the first turn is to the right, the second is to the left, the third is to the right and so on. Accordingly, odd time turns become right turns and even time turns become left turns.

Thus, the self-propelleds cleaner travels in a zigzag in the room while scanning obstacles and getting around them. Step S310 determines whether or not the self-propelled cleaner arrived at the terminal position. A cleaning travel terminates either when the self-propelled cleaner traveled along the wall after the second turn and then detected an obstacle, or when the self-propelled cleaner moved into the already traveled area. That is, the former is a terminating condition that occurs after the last end-to-end zigzag travel, and the latter is a terminating condition that occurs when a cleaning travel is started again upon discovery of a not-yet cleaned area as described below.

If neither of these terminating conditions is satisfied, the cleaning travel is repeated from step S210. If either terminating condition is satisfied, the subroutine for this cleaning travel is terminated and control returns to the process shown in FIG. 7.

After returning to that process, step S160 determines whether there is any not yet cleaned area, based on the previous travel route and situations around the travel route. Various well known methods can be used for determining whether or not not-yet cleaned areas exist, for example, the method of mapping and storing a past travel route can be used. In this embodiment, the past travel route and the presence or absence of walls detected during the travel are being written on a map reserved in memory area, based on detection results of said rotary encoder. It is determined whether or not surrounding walls are continuous, surrounding areas of detected obstacles are also continuous, and the cleaning travel covered all the areas excluding the obstacles. If a not-yet cleaned area is found the self-propelled cleaner moves to the start point at the not-yet cleaned area in step S170, to resume a cleaning travel from step S150.

Even if several not-yet cleaned areas exist around the floor, it is possible to eliminate those areas eventually by repeating the detection of a not-yet cleaned area, whenever the cleaning travel terminating condition mentioned above is satisfied.

Now, the security mode operation will be described.

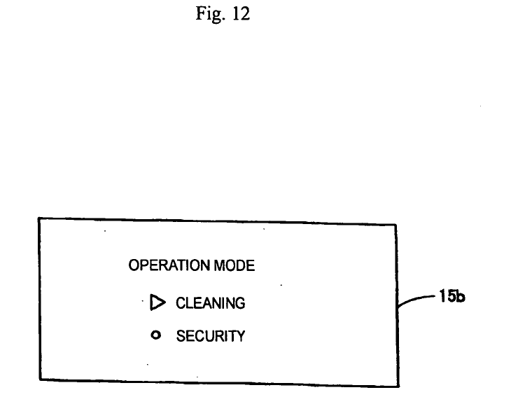

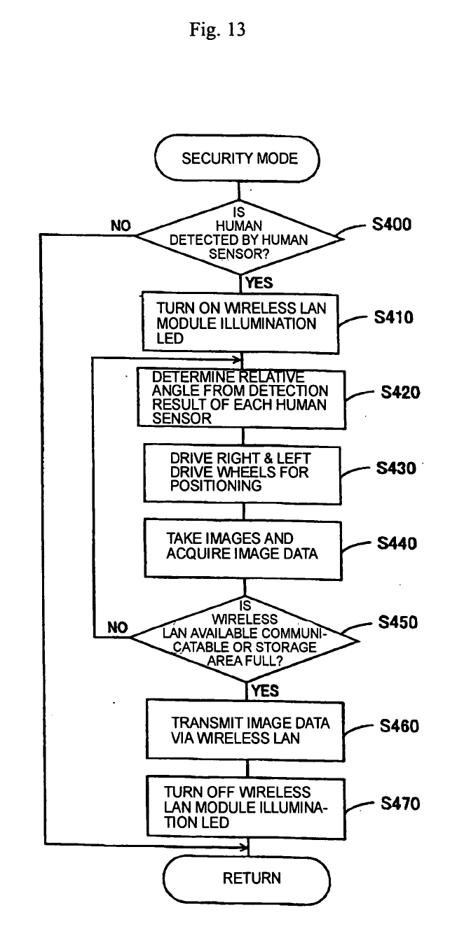

FIG. 12 shows an LCD panel 15b for operation mode selection. If a camera system unit 60 is mounted, operation mode can be selected. If security mode is selected with a operation switch 15a, a security mode operation is executed according to the flowchart shown in FIG. 13.

In security mode, detection results of each human sensor 21fr, 21rr, 21f1, 21r1 are input in step S400. If none of these human sensors did not detect a human, the security mode is finished once, and after other processing is performed the security mode is activated repeatedly at regular intervals.

If any of the human sensors 21fr, 21rr, 21f1, 21r1 detects something like a human in step S400, the wireless LAN module 71 and the illumination LED 64 are turned off in step S410. Since the security mode must be activated at all times even when no occupant is present, power saving is highly required for a battery-operated self-propelled cleaner. Therefore, only the essential components are to be activated while the self-propelled cleaner is standing by, and the other components are turned on as needed. The wireless LAN module 71 is also not activated during a standby period, and turned on if something like a human is detected.

In step S420, a relative angle between a detected object and the body is detected based on detection results of each human sensor 21fr, 21rr, 21f1, 21r1. Each human sensor 21 either outputs the infrared intensity of a moving infrared-emitting object, or simply outputs the presence or absence of such an object.

In the latter case, i.e., infrared intensity is output, it is possible that not a single human sensor 21 but a plurality of human sensors 21 detect such an object. In this case, based on the detection outputs from two human sensors 21 that detect a stronger infrared, the direction (angle) of the moving infrared-emitting object is detected within an angle range of 90 degrees between the facing directions of these two human sensors. At this time, an intensity ratio of the detection outputs of the two human sensors 21 is calculated, and a table previously prepared by conducting experiments using said intensity ratio is referenced. Since the intensity ratio and the angle are stored correspondingly in this table, the angle of a detected object within said range can be determined. Furthermore, the angle relative to the body is determined based on the mounting position of the two human sensors 21, using detection results. For example, if two human sensors 21 that detected a stronger infrared are the right-side human sensors 21fr, 21rr, and an angle of 30 degrees on the side of the human sensor 21fr within a 90 degree range is determined by referencing the intensity ratios in said table, that angle is 30 degrees in front within a 90 degree range on the right side, and therefore the relative angle to the front of the body is 45+30=75 degrees.

On the other hand, in the case of simply detecting the presence or absence of an moving infrared-emitting object, only eight relative angles to the body are detected. That is, if only one of the human sensors 21 outputs a detection result, the angle of the mounting position of the human sensor 21 that outputs said detection result is the relative angle. If two human sensors 21 output detection results, the middle angle between the mounting positions of these two human sensors 21 is the relative angle, and if three human sensors 21 output detection results, the angle of the human sensor 21 is the relative angle. That is, when a plurality of human sensors are mounted at equal intervals, if even number of human sensors are mounted, the angle at a position in the middle of central two human sensors is the relative angle, and if odd number, the relative angle is the angle of the mounting position of a centermost human sensor.

In step S430, the left and right drive wheels are activated so that the front of the body is positioned to face said relative angle. This is a turn-around movement, i.e. a turn at the same position, and therefore a command is given to the motor drivers 41R, 41L to rotate the left and right drive wheel motors 42R,.42L by predetermined number of rotations.

In step S440, after the positioning above is finished, a command is given to the two CMOS cameras 61, 62 to take images, and after the images are taken the image data is stored. Giving the command and storing the data are performed through the bus 14 and the communication I/O 63.

After obtaining the image data, it is determined, in step S450, whether or not communications via the wireless LAN module is possible, or whether or not the memory area is full, and then steps S420 to S440 are repeated until either of these conditions are satisfied. That is, since the wireless LAN module 71 is not activated until being turned on in step S410, it usually takes some time to activate the wireless LAN and make it available for communications. Because of this, the image data cannot be always transmitted immediately after an image is taken, and therefore taking further images until the wireless LAN module becomes available for communication, rather than simply waiting for that state to come, may prevent possible loss of image taking opportunities. Accordingly, image taking is repeated until the communications are available.

The image data must be stored in the memory, but storage capacity is limited. Because of this, it is not always possible to continue an image taking operation throughout the standby period, and therefore an image taking operation is stopped if the memory area becomes full.

If either condition is satisfied in step S450, the image date is transmitted through the wireless LAN in step S460, the wireless LAN module and the illumination LED 64 are turned off. Thereafter, the security mode is periodically activated again to continue monitoring.

Meanwhile, it is desirable to obtain the image data from both of the two CMOS cameras 61, 62. However, it is possible for the user to select a serial image taking with a wide angle camera or a serial image taking with a standard angle camera. It is also possible, though anomalistic, to take only one image with a wide angle camera and thereafter use a standard angle camera. This is because, if it takes time to transfer image data, in view of the time required to transfer a plurality of image data, there is a case where obtaining the plurality of images taken with the standard angle camera is more meaningful than obtaining more than one image taken by the wide angle camera. Also possible is to slightly turn the body after taking an image and take another image, and so on, in order to compensate for the narrow imaging range of the standard angle camera. In this case, it is possible to first take an image with the camera faced in the direction of eliminating said relative angle, then slightly turn the body to the left relative to the previous position and take an image, and turn to the right and take an image, and so on. Needless to say, imaging range can be widened by increasing gradually the extent of the turn.

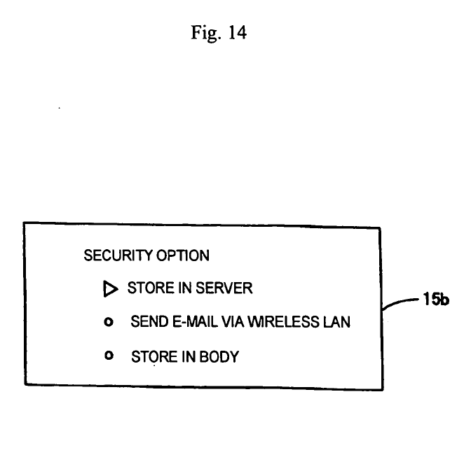

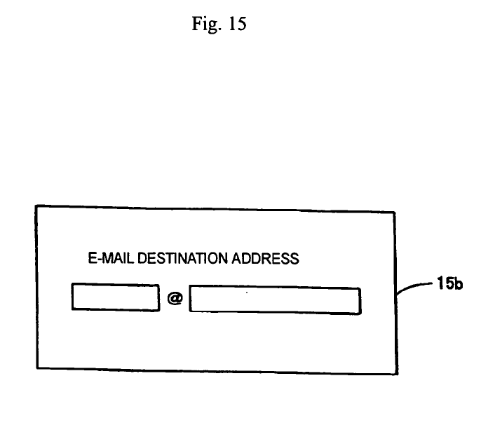

In the embodiment described above, image data is transmitted through a wireless LAN. It may be transmitted to a predetermined storage area of a server, or transmitted as an attachment to an E-mail via the Internet. In this case, there is available a security option that allows transmission method to be selected with the LCD panel 15b as shown in FIG. 14. The example shown here displays “Save to server”, “Transmit E-mail via wireless LAN”, and “Store in body”, one of which can be selected with an operation switch 15a. When transmitting by an E-mail, the destination of an E-mail can be set as shown in FIG. 15.

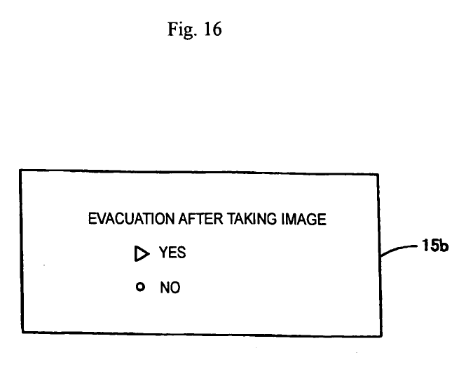

In the above embodiment, only the image taking and transmitting operations are performed. After an image is taken, the image data cannot be transmitted through a wireless LAN for some time, and during that time the body may be broken by an intruder. To prevent this, it is possible to allow the self-propelled cleaner to evacuate after taking images. FIG. 16 shows a selection screen of the LCD panel 15b on which evacuation behavior can be selected. As an evacuation behavior, backing zigzag or fleeing into a predetermined shelter is conceivable. A narrow space such as between two pieces of furniture where this self-propelled cleaner can move into is desirable.

It is also possible to take surrounding images with a plurality of camera devices on a routine basis, and detect an intruder based on the images taken, thus making the human sensors unnecessary. In this case, two images are taken at predetermined intervals with the self-propelled cleaner at rest, and if there is a difference between the two images, it is determined that an intruder is detected. In addition, a relative angle between the intruder and the body is determined based on where in the images has changed.

Thus, according to the present invention, images of an intruder are taken with a plurality of camera devices each with a different VF angle and elevation angle, the images taken are input, and then output in a predetermined manner. This makes it possible to prevent loss of image taking opportunity with a simple configuration.

1. A self-propelled cleaner having a body equipped with a cleaning mechanism and a drive mechanism equipped with drive wheels that are disposed at both sides of said body and their rotations can be controlled individually to enable steering and driving of said self-propelled cleaner,
said body comprising:
a standard VF angle camera device and a wide VF angle camera device, said wide VF angle camera device being fixed at an elevation angle so that the floor is within the VF angle and said standard VF camera being fixed at an elevation angle lower than said elevation angle of the wide VF angle camera device;
a plurality of human sensors that are disposed at the sides of the body and detect an infrared-emitting object, based on changes in the amount of received infrared light; and
an image output processor that determines a relative angle between the intruder and said body based on the detection results of these plurality of human sensors, changes the rotation angle of said body so as to eliminate said relative angle, causes said camera devices to take images of the intruder, and transmits the image data to the outside via a wireless LAN according to a predetermined protocol.

2. A self-propelled cleaner having a body equipped with a cleaning mechanism and a drive mechanism capable of steering and driving said self-propelled cleaner, said body comprising:
a plurality of camera devices each with a different VF angle and mounted each at a different elevation angle;
a plurality of human sensors that detect the presence and direction of a human around the body; and
an image output processor that faces said body toward the human detected based on the detection results of said human sensor, takes images of the human with each of said plurality of camera devices, inputs the image data, and then outputs said image data in a predetermined manner.

3. A self-propelled cleaner of claim 2, wherein:
the plurality of camera devices consist of a standard VF angle camera device and a wide VF angle camera device,
wherein the elevation angle of the standard VF angle camera is lower than that of the wide VF angle camera, and the wide VF angle camera device has an elevation angle within which part of the floor is included.

4. A self-propelled cleaner of claim 3, wherein:
said wide VF angle camera device is a wide angle lens camera with a VF angle of 110 degrees, and is mounted on the base board so that shooting direction is at right angle to the base board,
wherein the base board itself is mounted on the mounting base tilted at 45 degrees, and therefore the imaging range becomes from 10 to 110 degrees below the horizontal plane.

5. A self-propelled cleaner of claim 3, wherein:
said standard VF angle camera device is a standard lens camera with a VF angle of 58 degrees, and is mounted on said base board with a wedge-shaped adapter placed under it,
wherein the imaging range becomes from 1 to 57 degrees relative to horizontal direction since the VF angle is 58 degrees.

6. A self-propelled cleaner of claim 2, wherein:
said plurality of human sensors detect an infrared-emitting object based on changes in the amount of received infrared light and disposed at the sides of said body.

7. A self-propelled cleaner of claim 6, wherein
said image output processor detects a relative angle between the human and said body based on detection result of the plurality of human sensors, changes the rotation angle of said body so as to eliminate said relative angle, and causes said camera devices to take images.

8. A self-propelled cleaner of claim 7, wherein:
a plurality of said human sensors outputting the detection of the presence of an infrared-emitting object are disposed at equal intervals, if only one of the human sensors outputs a detection result, the angle of the mounting position of the human sensor that outputs said detection result is the relative angle, if two human sensors output detection results, the middle angle between the mounting positions of these two human sensors is the relative angle, and if three human sensors output detection results, the angle of the mounting position of the middle human sensor is the relative angle.

9. A self-propelled cleaner of claim 2, wherein:
said image output processor is equipped with a wireless transmitter to transmit the image data taken with said camera devices to the outside.

10. A self-propelled cleaner of claim 9, wherein:
said wireless transmitter is a wireless LAN module, and said image output processor transmits the image data taken with said plurality of camera devices according to a predetermined protocol.

11. A self-propelled cleaner of claim 9, wherein:
said image output processor temporarily stores the image data taken with said plurality of camera devices, and transmits them when said wireless transmitter becomes available for transmission.

12. A self-propelled cleaner of claim 11, wherein:
said image output processor continues to take images with said plurality of camera devices as long as a human is detected by said human sensors, and transmits the image data through said wireless transmitter after a predetermined number of images are taken, or when said human sensors do not detect the human any more.

13. A self-propelled cleaner of claim 2, wherein:
an illumination device is provided that face the imaging range of said plurality of camera devices, and said image output processor faces said body toward the detected human and also illuminates the imaging range with said illumination device.

14. A self-propelled cleaner of claim 2, wherein:
continuous image taking with a wide angle camera or continuous image taking with a standard camera can be selected by a user.

15. A self-propelled cleaner of claim 2, wherein:
a user can select a mode in which only one image is taken with a wide VF angle camera device and subsequent images are taken with a standard VF angle camera device.

16. A self-propelled cleaner of claim 15, wherein:
the body is slightly turned after taking an image, and another image is taken, and so on, in order to compensate for the narrow imaging range of a standard VF angle camera device.

17. A self-propelled cleaner of claim 16, wherein:
when taking images, first face the body toward a direction of eliminating said relative angle, then slightly turn the body to the left, and then slightly to the right.

18. A self-propelled cleaner of claim 17, wherein:
when taking images, after turning the body to the left as described above, turn the body to the right little by little so that the imaging range is widened.
